(19) United States
(12) Patent Application Publication
(10) Pub. No.: US 2024/0014978 A1
(43) Pub. Date: Jan. 11, 2024

(54) Data Communication with Adaptable Feedback Mode

(71) Applicant: Nokia Technologies Oy, Espoo (FI)

(72) Inventors: Lianghai Ji, Aalborg (DK); Vinh VAN PHAN, Oulu (FI); Ling YU, Kaunlainen (FI); Rudraksh SHRIVASTAVA, Erlighelm (DE); Sudeep HEGDE, Stuttgart (DE)

(21) Appl. No.: 18/037,409

(22) PCT Filed: Nov. 19, 2020
(86) PCT No.: PCT/EP2020/082621

§ 371 Date: May 17, 2023

(51) Int. Cl. H04L 5/00; H04L 1/1812

(52) U.S. Cl. CPC H04L 5/0053; H04L 1/1812

(57) ABSTRACT

Various example embodiments relate to providing feedback with an adaptive acknowledgement mode. A device may transmit an allocation of transmission resource(s) associated with a second acknowledgement mode. The second acknowledgement mode may include transmission of a positive acknowledgement and a negative acknowledgement. Another device may detect a condition to switch to a first acknowledgement mode including transmission of the negative acknowledgement and not transmission of the positive acknowledgement. The other device may transmit an indication of a switch to the first acknowledgement mode. Apparatuses, methods, and computer programs are disclosed.

### TECHNICAL FIELD

Various example embodiments generally relate to the field of data communications. In particular, some example embodiments relate to providing feedback with an adaptive acknowledgement mode.

### BACKGROUND

In various wireless communication systems, for example 3GPP 5G new radio (NR), a device may communicate with one or more other devices over a sidelink connection. Reliability of the communication may be improved by retransmission of data, for example according to a HARQ process. Data communication may be based on a protocol stack comprising various communication protocols and layers such as for example a packet data convergence protocol (PDCP) layer, a radio link control (RLC) layer, a medium access control (MAC) layer, and a physical layer (PHY). HARQ functionality may be provided on the MAC layer.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments enable to reduce collisions between HARQ feedback and other communications or to save power. These benefits may be achieved by the features of the independent claims. Further implementation forms are provided in the dependent claims, the description, and the drawings.

According to a first aspect, an apparatus may comprise at least one processor and at least one memory including computer program code, the at least one memory and the computer code configured to, with the at least one processor, cause the apparatus at least to: receive an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; detect a condition to switch to a first acknowledgement mode comprising transmission of the negative acknowledgement and not transmission of the positive acknowledgement; and transmit an indication of a switch from the second acknowledgement mode to the first acknowledgement mode.

According to an example embodiment of the first aspect, the condition to switch to the first acknowledgement mode may comprise detecting at least one collision between the at least one first feedback transmission resource and another communication, or the condition to switch to the first acknowledgement mode may comprise detecting entry to a power saving mode.

According to an example embodiment of the first aspect, the at least one memory and the computer code may be further configured to, with the at least one processor, cause the apparatus to: receive sidelink control information comprising an indication of the allocation of the at least one transmission resource. The at least one transmission resource may be allocated to sidelink transmission to one or multiple sidelink receivers. The at least one first feedback transmission resource may be dedicated to one of the one or multiple sidelink receivers.

According to an example embodiment of the first aspect, the at least one memory and the computer code may be further configured to, with the at least one processor, cause the apparatus to: determine to switch to the first acknowledgement mode further based on detecting or measuring at least one radio channel condition.

According to an example embodiment of the first aspect, the at least one radio channel condition may comprise a received signal strength and/or a channel busy ratio. The at least one memory and the computer code may be further configured to, with the at least one processor, cause the apparatus to: determine to switch to the first acknowledgement mode if the received signal strength is above a first threshold; and/or determine to switch to the first acknowledgement mode if the channel busy ratio is below a second threshold.

According to an example embodiment of the first aspect, the at least one memory and the computer code may be further configured to, with the at least one processor, cause the apparatus to: determine to transmit a control message indicative of the switch to the first acknowledgement mode.

According to an example embodiment of the first aspect, the control message may comprise an indication of applying the first acknowledgement mode to a subset of a plurality of the allocated transmission resources.

According to an example embodiment of the first aspect, the at least one memory and the computer code may be further configured to, with the at least one processor, cause the apparatus to: transmit the negative acknowledgement in the first acknowledgement mode on the at least one first feedback transmission resource; or transmit the negative acknowledgement in the first acknowledgement mode on at least one second feedback transmission resource.

According to an example embodiment of the first aspect, the indication of the switch from the second acknowledgement mode to the first acknowledgement mode may comprise a positive or negative acknowledgement transmitted on the at least one second feedback transmission resource. The second feedback transmission resource may be configured for indicating a switch of acknowledgement mode. The at least one second feedback transmission resource may be different from the at least one first transmission resource.

According to an example embodiment of the first aspect, the at least one memory and the computer code may be further configured to, with the at least one processor, cause the apparatus to: transmit an indication of returning to the second acknowledgement mode. The indication of returning to the second acknowledgement mode may comprise at least one positive acknowledgement transmitted on the at least one first feedback transmission resource.

According to an example embodiment of the first aspect, the at least one memory and the computer code may be further configured to, with the at least one processor, cause the apparatus to: transmit the indication of the switch from the second acknowledgement mode to the first acknowledgement mode to a sidelink transmitter and/or to the one or multiple sidelink receivers.

According to an example embodiment of the first aspect, the at least one memory and the computer code may be further configured to, with the at least one processor, cause the apparatus to: receive a configuration of the at least one second feedback transmission resource from at least one of: an upper protocol layer, the sidelink transmitter, the one or multiple sidelink receivers, or a base station.

According to an example embodiment of the first aspect, the at least one second feedback transmission resource may be common to the multiple sidelink receivers.

According to an example embodiment of the first aspect, the indication of the switch from the second acknowledgement mode to the first acknowledgement mode may comprise a configured pattern of: one or more skipped acknowledgements, one or more positive acknowledgements, and/or one or more negative acknowledgements.

According to an example embodiment of the first aspect, the at least one memory and the computer code may be further configured to, with the at least one processor, cause the apparatus to: determine to transmit the indication of the switch from the second acknowledgement mode to the first acknowledgement mode, in response to prioritizing acknowledgement of data associated with the at least one allocated transmission resource over the other communication; or determine to transmit the control message indicative of the switch to the first acknowledgement mode, in response to prioritizing the other communication over the acknowledgement of the data associated with the at least one allocated transmission resource.

According to a second aspect, a method may comprise: receiving an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; detecting a condition to switch to a first acknowledgement mode comprising transmission of the negative acknowledgement and not transmission of the positive acknowledgement; and transmitting an indication of a switch from the second acknowledgement mode to the first acknowledgement mode.

According to an example embodiment of the second aspect, the condition to switch to the first acknowledgement mode may comprise detecting at least one collision between the at least one first feedback transmission resource and another communication, or the condition to switch to the first acknowledgement mode may comprise detecting entry to a power saving mode.

According to an example embodiment of the second aspect, the method may further comprise: receiving sidelink control information comprising an indication of the allocation of the at least one transmission resource. The at least one transmission resource may be allocated to sidelink transmission to one or multiple sidelink receivers. The at least one first feedback transmission resource may be dedicated to one of the one or multiple sidelink receivers.

According to an example embodiment of the second aspect, the method may further comprise determining to switch to the first acknowledgement mode further based on detecting or measuring at least one radio channel condition.

According to an example embodiment of the second aspect, the at least one radio channel condition may comprise a received signal strength and/or a channel busy ratio. The method may further comprise: determining to switch to the first acknowledgement mode if the received signal strength is above a first threshold; and/or determining to switch to the first acknowledgement mode if the channel busy ratio is below a second threshold.

According to an example embodiment of the second aspect, the method may further comprise determining to transmit a control message indicative of the switch to the first acknowledgement mode.

According to an example embodiment of the second aspect, the control message may comprise an indication of applying the first acknowledgement mode to a subset of a plurality of the allocated transmission resources.

According to an example embodiment of the second aspect, the method may further comprise transmitting the negative acknowledgement in the first acknowledgement mode on the at least one first feedback transmission resource; or transmitting the negative acknowledgement in the first acknowledgement mode on at least one second feedback transmission resource.

According to an example embodiment of the second aspect, the indication of the switch from the second acknowledgement mode to the first acknowledgement mode may comprise a positive or negative acknowledgement transmitted on the at least one second feedback transmission resource. The second feedback transmission resource may be configured for indicating a switch of acknowledgement mode. The at least one second feedback transmission resource may be different from the at least one first transmission resource.

According to an example embodiment of the second aspect, the method may further comprise transmitting an indication of returning to the second acknowledgement mode. The indication of returning to the second acknowledgement mode may comprise at least one positive acknowledgement transmitted on the at least one first feedback transmission resource.

According to an example embodiment of the second aspect, the method may further comprise transmitting the indication of the switch from the second acknowledgement mode to the first acknowledgement mode to a sidelink transmitter and/or to the one or multiple sidelink receivers.

According to an example embodiment of the second aspect, the method may further comprise receiving a configuration of the at least one second feedback transmission resource from at least one of: an upper protocol layer, the sidelink transmitter, the one or multiple sidelink receivers, or a base station.

According to an example embodiment of the second aspect, the at least one second feedback transmission resource may be common to the multiple sidelink receivers.

According to an example embodiment of the second aspect, the indication of the switch from the second acknowledgement mode to the first acknowledgement mode may comprise a configured pattern of: one or more skipped acknowledgements, one or more positive acknowledgements, and/or one or more negative acknowledgements.

According to an example embodiment of the second aspect, the method may further comprise determining to transmit the indication of the switch from the second acknowledgement mode to the first acknowledgement mode, in response to prioritizing acknowledgement of data associated with the at least one allocated transmission resource over the other communication; or determining to transmit the control message indicative of the switch to the first acknowledgement mode, in response to prioritizing the other communication over the acknowledgement of the data associated with the at least one allocated transmission resource

According to a third aspect, a computer program may comprise instructions for causing an apparatus to perform at least the following: receiving an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; detecting a condition to switch to a first acknowledgement mode comprising transmission of the negative acknowledgement and not transmission of the positive acknowledgement; and transmitting an indication of a switch from the second acknowledgement mode to the first acknowledgement mode. The computer program may further comprise instructions for causing the apparatus to perform any example embodiment of the method of the second aspect.

According to a fourth aspect, an apparatus may comprise means for receiving an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; means for detecting a condition to switch to a first acknowledgement mode comprising transmission of the negative acknowledgement and not transmission of the positive acknowledgement; and means for transmitting an indication of a switch from the second acknowledgement mode to the first acknowledgement mode. The apparatus may further comprise means for performing any example embodiment of the method of the second aspect.

According to a fifth aspect, an apparatus may comprise at least one processor and at least one memory including computer program code, the at least one memory and the computer code configured to, with the at least one processor, cause the apparatus at least to: transmit an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; receive an indication of a switch to a first acknowledgement mode comprising transmission of the negative acknowledgement and not transmission of the positive acknowledgement; and determine whether to retransmit data based on the first acknowledgement mode.

According to an example embodiment of the fifth aspect, the at least one memory and the computer code may be further configured to, with the at least one processor, cause the apparatus to: retransmit the data. The data may be associated with the at least one allocated transmission resource.

According to an example embodiment of the fifth aspect, the at least one memory and the computer code may be further configured to, with the at least one processor, cause the apparatus to: transmit sidelink control information comprising an indication of the allocation of the at least one transmission resource, wherein the at least one transmission resource may be allocated to sidelink transmission to one or multiple sidelink receivers, and wherein the at least one first feedback transmission resource may be dedicated to one of the one or multiple sidelink receivers; and receive the indication of the switch from the second acknowledgement mode to the first acknowledgement mode from at least the one of the one or multiple sidelink receivers.

According to an example embodiment of the fifth aspect, the at least one memory and the computer code may be further configured to, with the at least one processor, cause the apparatus to: receive the negative acknowledgement in the first acknowledgement mode on the at least one first feedback transmission resource; or receive the negative acknowledgement in the first acknowledgement mode on at least one second feedback transmission resource.

According to an example embodiment of the fifth aspect, the indication of the switch from the second acknowledgement mode to the first acknowledgement mode may comprise a positive or negative acknowledgement received on the at least one second feedback transmission resource. The second feedback transmission resource may be configured for indicating a switch of acknowledgement mode. The at least one second feedback transmission resource may be different from the at least one first feedback transmission resource.

According to an example embodiment of the fifth aspect, the at least one memory and the computer code may be further configured to, with the at least one processor, cause the apparatus to: receive an indication of returning to the second acknowledgement mode. The indication of returning to the second acknowledgement mode may comprise at least one positive acknowledgement transmitted on the at least one first feedback transmission resource.

According to an example embodiment of the fifth aspect, the at least one memory and the computer code may be further configured to, with the at least one processor, cause the apparatus to: transmit a configuration of the at least one second feedback transmission resource to the one or multiple sidelink receivers.

According to an example embodiment of the fifth aspect, the at least one second feedback transmission resource may be common to the one or multiple of sidelink receivers.

According to an example embodiment of the fifth aspect, the at least one memory and the computer code may be further configured to, with the at least one processor, cause the apparatus to: detect the indication of the switch from the second acknowledgement mode to the first acknowledgement mode based on detecting a missing feedback from the one of the one or multiple sidelink receivers on the at least one first feedback transmission resource.

According to an example embodiment of the fifth aspect, the at least one memory and the computer code may be further configured to, with the at least one processor, cause the apparatus to: detect the indication of the switch from the second acknowledgement mode to the first acknowledgement mode further based on detecting the positive or negative acknowledgement on the at least one second feedback transmission resource.

According to an example embodiment of the fifth aspect, the indication of the switch from the second acknowledgement mode to the first acknowledgement mode may comprise a preconfigured feedback pattern of: one or more skipped acknowledgements, one or more positive acknowledgements, and/or one or more negative acknowledgements.

According to an example embodiment of the fifth aspect, the at least one memory and the computer code may be further configured to, with the at least one processor, cause the apparatus to: determine to postpone retransmission of the data associated with the at least one allocated transmission resource based on the skipped acknowledgements of the preconfigured feedback pattern; and determine to transmit further data associated with the at least one allocated transmission resource before retransmission of the data.

According to an example embodiment of the fifth aspect, the indication of the switch from the second acknowledgement mode to the first acknowledgement mode may comprise a control message indicative of the switch to the first acknowledgement mode.

According to an example embodiment of the fifth aspect, the control message may comprise an indication of applying the first acknowledgement mode to a subset of a plurality of the allocated transmission resources. The at least one memory and the computer code may be further configured to, with the at least one processor, cause the apparatus to: determine whether to retransmit the data associated with the at least one allocated transmission resource based on applying the first acknowledgement mode to the subset of the plurality of the allocated transmission resources.

According to a sixth aspect, a method may comprise: transmitting an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; receiving an indication of a switch to a first acknowledgement mode comprising transmission of the negative acknowledgement and not transmission of the positive acknowledgement; and determining whether to retransmit data based on the first acknowledgement mode.

According to an example embodiment of the sixth aspect, the method may further comprise retransmitting the data. The data may be associated with the at least one allocated transmission resource.

According to an example embodiment of the sixth aspect, the method may further comprise transmitting sidelink control information comprising an indication of the allocation of the at least one transmission resource, wherein the at least one transmission resource may be allocated to sidelink transmission to one or multiple sidelink receivers, and wherein the at least one first feedback transmission resource may be dedicated to one of the one or multiple sidelink receivers; and receiving the indication of the switch from the second acknowledgement mode to the first acknowledgement mode from at least the one of the one or multiple sidelink receivers.

According to an example embodiment of the sixth aspect, the method may further comprise receiving the negative acknowledgement in the first acknowledgement mode on the at least one first feedback transmission resource; or receiving the negative acknowledgement in the first acknowledgement mode on at least one second feedback transmission resource.

According to an example embodiment of the sixth aspect, the indication of the switch from the second acknowledgement mode to the first acknowledgement mode may comprise a positive or negative acknowledgement received on the at least one second feedback transmission resource. The second feedback transmission resource may be configured for indicating a switch of acknowledgement mode. The at least one second feedback transmission resource may be different from the at least one first feedback transmission resource.

According to an example embodiment of the sixth aspect, the method may further comprise receiving an indication of returning to the second acknowledgement mode. The indication of returning to the second acknowledgement mode may comprise at least one positive acknowledgement transmitted on the at least one first feedback transmission resource.

According to an example embodiment of the sixth aspect, the method may further comprise transmitting a configuration of the at least one second feedback transmission resource to the one or multiple sidelink receivers.

According to an example embodiment of the sixth aspect, the at least one second feedback transmission resource may be common to the one or multiple of sidelink receivers.

According to an example embodiment of the sixth aspect, the method may further comprise detecting the indication of the switch from the second acknowledgement mode to the first acknowledgement mode based on detecting a missing feedback from the one of the one or multiple sidelink receivers on the at least one first feedback transmission resource.

According to an example embodiment of the sixth aspect, the method may further comprise detecting the indication of the switch from the second acknowledgement mode to the first acknowledgement mode further based on detecting the positive or negative acknowledgement on the at least one second feedback transmission resource.

According to an example embodiment of the sixth aspect, the indication of the switch from the second acknowledgement mode to the first acknowledgement mode may comprise a preconfigured feedback pattern of: one or more skipped acknowledgements, one or more positive acknowledgements, and/or one or more negative acknowledgements.

According to an example embodiment of the sixth aspect, the method may further comprise: determining to postpone retransmission of the data associated with the at least one allocated transmission resource based on the skipped acknowledgements of the preconfigured feedback pattern; and determining to transmit further data associated with the at least one allocated transmission resource before retransmission of the data.

According to an example embodiment of the sixth aspect, the indication of the switch from the second acknowledgement mode to the first acknowledgement mode may comprise a control message indicative of the switch to the first acknowledgement mode.

According to an example embodiment of the sixth aspect, the control message may comprise an indication of applying the first acknowledgement mode to a subset of a plurality of the allocated transmission resources. The method may further comprise determining whether to retransmit the data associated with the at least one allocated transmission resource based on applying the first acknowledgement mode to the subset of the plurality of the allocated transmission resources.

According to a seventh aspect, a computer program may comprise instructions for causing an apparatus to perform at least the following: transmitting an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; receiving an indication of a switch to a first acknowledgement mode comprising transmission of the negative acknowledgement and not transmission of the positive acknowledgement; and determining whether to retransmit data based on the first acknowledgement mode. The computer program may further comprise instructions for causing the apparatus to perform any example embodiment of the method of the sixth aspect.

According to an eighth aspect, an apparatus may comprise means for transmitting an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource; means for receiving an indication of a switch to a first acknowledgement mode comprising transmission of the negative acknowledgement and not transmission of the positive acknowledgement; and means for determining whether to retransmit data based on the first acknowledgement mode. The apparatus may further comprise means for performing any example embodiment of the method of the sixth aspect.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a communication network comprising network nodes and devices, according to an example embodiment;

FIG. 2 illustrates an example of an apparatus configured to practice one or more example embodiments;

FIG. 3 illustrates an example of communication between devices to prioritize between HARQ feedback and other activities, according to an example embodiment;

FIG. 4 illustrates an example of a method for providing acknowledgements, according to an example embodiment; and

FIG. 5 illustrates an example of a method for receiving acknowledgements, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Devices, such as for example user equipment (UE), may be enabled to access services through a radio access network (RAN). In addition, the devices may be enabled to communicate with each other over sidelink connections. Sidelink functionality may be used for example to support advanced vehicle-to-anything (V2X) communications and other new type of services. Therefore, it may be desired to improve communications for example to achieve higher reliability and lower latency. One possibility to improve efficiency of the communication is to apply groupcasting, where same data is transmitted to multiple devices. For example, in sidelink groupcast transmission a sidelink transmitter (SL Tx) user equipment (UE) may be configured to multicast data to a group of sidelink receiver (SL Rx) UEs. In order to improve reliability of groupcast transmission, acknowledgement schemes such as HARQ may be applied. This enables for example a sidelink transmitter UE to be aware of the reception status at the sidelink receiver UEs. In other words, after the sidelink transmitter UE groupcasts sidelink control information (SCI) and corresponding payload data over selected and allocated transmission channel resource(s), for example on a physical sidelink control channel (PSSCH) and/or a physical sidelink shared channel (PSSCH), a sidelink receiver UE involved in the groupcast may indicate its reception status over a feedback channel, for example a physical sidelink feedback channel (PSFCH), associated with the transmission channel resource(s).

Data communication between devices may be based on a protocol stack comprising multiple interconnected protocol layers, where the different layers may provide different functionality. For example, the medium access control (MAC) layer may be configured to provide error correction functionality based on acknowledgements and retransmissions, for example according to a hybrid automatic repeat request (HARQ) scheme. The MAC layer may be configured to provide payload data to the physical layer as transport blocks (TB). A HARQ process may include acknowledging reception of transport blocks and/or retransmission of transport blocks.

HARQ operation may be configured according to different HARQ modes. According to a first HARQ mode, a sidelink receiver UE within a range of the sidelink transmitter UE may transmit a non-acknowledgement (NACK) feedback if it successfully decodes the sidelink control information (SCI) but fails in decoding the payload data. Otherwise, the sidelink receiver UE may not transmit any feedback. A NACK may be also called a negative acknowledgement. The first HARQ mode may be also called a negative-only acknowledgement mode or a NACK-only mode. In the first HARQ mode, the sidelink receiver UEs may use common or shared PSFCH resource(s) to transmit the NACK. The common or shared PSFCH resource(s) may be determined based on predefined rule(s), for example based on the starting-subchannel or subchannels and the slot used for the associated PSSCH transmissions and a Layer-1 (L1) source ID provided by the SCI. In some sidelink groupcast systems the NACK-only mode may comprise different sidelink receiver UEs transmitting the NACKs on same common or shared PSFCH resource(s). However, example embodiments of the present disclosure enable a NACK-only mode where different UEs may transmit their NACKs on different PSFCH resources dedicated to respective UEs.

According to a second HARQ mode, a sidelink receiver UE may be configured to send either a positive acknowledgement (ACK), if it successfully receives the SCI and payload data from the PSCCH and PSSCH; a NACK, if it successfully decodes the SCI but fails in decoding the data payload; or nothing, if it does not detect or successfully decode the SCI. This second HARQ mode may be also called the positive-negative acknowledgement (P-N ACK) mode. In the second HARQ mode, each of the sidelink receiver UEs may send their feedback over dedicated feedback resource(s), for example on the PSFCH. In order to determine the dedicated feedback resource(s), a sidelink receiver may use its group member identifier (ID) in addition to the information listed above for the first acknowledgement mode (e.g. the starting-subchannel or subchannels and the slot used for the associated PSSCH transmissions and the L1 source ID). The group member ID may a unique ID within the considered group of sidelink receiver UEs. The second HARQ mode may be used for example if a V2X layer passes the group size and the group member ID to an access stratum (AS) layer and the group size is not greater than the number of candidate feedback resource(s) (e.g. on PSSCH) associated with the selected transmission resource(s) (e.g. on PSSCH). Accordingly, when the sidelink transmitter UE groupcasts its data, the associated SCI may indicate the HARQ mode that should be used by the intended sidelink receiver UEs to send their feedbacks. If both acknowledgement modes may be applied, the MAC layer of the sidelink transmitter UE may determine which mode to use. The first and second HARQ modes are provided as examples of first and second acknowledgement modes, respectively.

In order to improve reliability, latency, power consumption, and/or communication efficiency, example embodiments of the present disclosure provide a flexible approach with a device-specific and dynamically adaptable acknowledgement mode for groupcast communication. The example embodiments may be for example applied to support public safety and advanced V2X services, network controlled interactive services, gap analysis for railways, enhanced relays for energy efficient and extensive coverage, or audio-visual service production. Power saving enables UEs with limited battery capability to perform sidelink operations in a power efficient manner. In some applications, sidelink communication may be designed based on an assumption that the UEs are always powered on when operating on the sidelink, e.g., focusing on UEs installed in vehicles with sufficient battery capacity. Solutions that enable power saving may be applied for example to vulnerable road users (VRUs) in V2X use cases, and to UEs in public safety and commercial use cases, where power consumption of the UEs is desired to be minimized.

Enhanced reliability and reduced latency allow to support URLLC (ultra reliable low latency communication) type of sidelink use cases in various operating scenarios. The system level reliability and latency performance of the sidelink may be however affected by the communication conditions such as the wireless channel status and the offered load. Therefore, performance of the sidelink may not be sufficient in terms of reliability and latency in some conditions, for example when the channel is relatively busy. Solutions that enhance reliability and reduce latency are therefore desired in order to support use cases requiring low latency and high reliability under such communication conditions.

According to an example embodiment, a device may transmit an allocation of transmission resource(s) associated with a second acknowledgement mode. The second acknowledgement mode may comprise transmission of a positive acknowledgement and a negative acknowledgement. Another device may detect a condition to switch to a first acknowledgement mode comprising transmission of the negative acknowledgement and not comprising transmission of the positive acknowledgement. The other device transmit an indication of a switch to the first acknowledgement mode. This enables to reduce collisions between transmission of positive acknowledgements and other communications or to reduce power consumption.

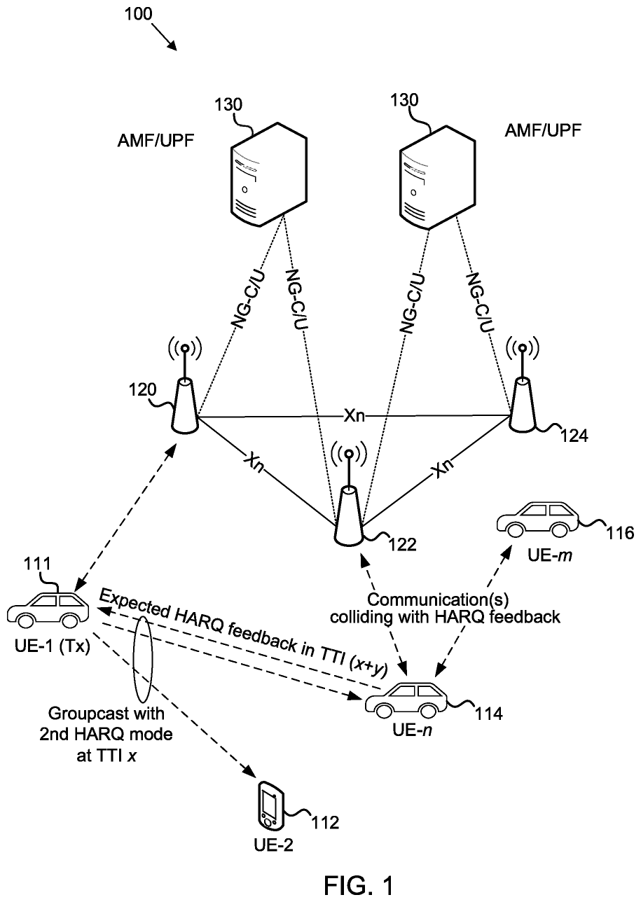

FIG. 1 illustrates an example of a communication network comprising network nodes and devices, according to an example embodiment. The communication network 100 may comprise one or more core network elements such as for example access and mobility management function (AMF) and/or user plane function (UPF) 130, one or more base stations 120, 122, 124. The communication network 100 may further comprise one or more devices, which may be also referred to as a user nodes or user equipment (UE). A UE may comprise for example a vehicle, mobile phone, or any other device able or unable to communicate with the base stations 120, 122, 124. For example, the communication network 100 may comprise a UE-1 111, UE-2 112, UE-n 114, and/or UE-m 116. The UE-1 111 may operate as a sidelink transmitter UE. The UEs 111, 112, 114, 116 may communicate with zero or more of the base stations 120, 122, 124 via wireless radio channel(s). Furthermore, the UE-1 111 may communicate with the UE-2 112 and UE-n 114 over sidelink connection(s). A sidelink connection may be a direct radio connection between UEs. UE-1 111 may for example act as a link between the base station 120 and UE-2 112 or UE-n 114.

The base stations may be configured to communicate with the core network elements over a communication interface, such as for example a control plane interface or a user plane interface NG-C/U. Base stations may be also called radio access network (RAN) nodes and they may be part of a radio access network between the core network and the UEs. Functionality of a base station may be distributed between a central unit (CU), for example a gNB-CU, and one or more distributed units (DU), for example gNB-DUs. Network elements AMF/UPF, gNB, gNB-CU, and gNB-DU may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

The communication network 100 may be configured for example in accordance with the 5th Generation digital cellular communication network, as defined by the 3rd Generation Partnership Project (3GPP). In one example, the communication network 100 may operate according to 3GPP 5G NR (5G New Radio). It is however appreciated that example embodiments presented herein are not limited to this example network and may be applied in any present or future wireless or wired communication networks, or combinations thereof, for example other type of cellular networks, short-range wireless networks, broadcast or multicast networks, or the like.

UE-1 111 may be configured transmit data as a groupcast to a group of UEs (e.g. UE2, UE3, . . . , UE-n). In groupcasting the transmitted data may be addressed to members of the group of UEs. The data may be transmitted to the group of UEs using same transmission resources, for example on PSCCH and/or PSSCH resources. The UE-1 111 may apply the second HARQ mode (P-N ACK) for its periodic data transmissions over PSCCH and/or PSSCH to the intended group of sidelink receiver UEs. In the second HARQ mode, the sidelink receiver UEs may be configured to transmit their feedbacks over their respective dedicated PSFCH resources based on their reception statuses. However, any of the sidelink receiver UEs, for example UE-n 114, may have other activities overlapping in time-domain with the PSFCH resources associated with the PSFCH and/or PSFCH resources used by UE-1 111 to transmit/groupcast its data. For example, the UE-n 114 may have other transmissions or receptions, for example over the sidelink, uplink (UL), and/or downlink (DL), which overlap with the considered PSFCH transmissions, for example periodically in time domain.

Thus, if the UE-n 114 is restricted to half-duplex operation and/or the UE-n 114 does not support simultaneous reception or transmission of sidelink communication with another UE and PSFCH transmission to UE-1 111, the UE-n 114 may determine to prioritize or deprioritize the considered PSFCH transmission, for example in a periodic manner. If the considered PSFCH transmission is deprioritized over other communication activities, the UE-1 111 may detect the missing (DTX-ed) HARQ feedback from the UE-n 114. DTX-ed HARQ feedback may comprise not transmitting HARQ feedback by a particular UE via its PSFCH resource. Thus, the UE-1 111 may consider the previous transmission attempt as failed and proceed to retransmit. This introduces resource waste if the UE-n 114 successfully received the previous transmission but determined to deprioritize the acknowledgement on the PSFCH. On the other hand, prioritizing the considered PSFCH transmission over other transmission or reception activities would have a negative impact for the other activities, for example if the other activities have high reliability and/or low latency requirements.

With reference to FIG. 1, if the UE-1 111 applies groupcast transmission to the group of UEs (UE2, UE3, . . . , UE-n), as illustrated in FIG. 1, the second HARQ mode (P-N ACK) may be enabled for transmission time interval (TTI) x. Hence, UE-n 114 may be expected to provide HARQ feedback at TTI (x+y), which is associated with the TTI x. However, the UE-n 114 may have scheduled communications to/from base station 122 and/or UE-m 116 at the same TTI (x+y). UE-m 116 may also be part of the considered groupcast from UE-1 111. These communications may therefore collide with the expected HARQ feedback at UE-n 114. Consequently the UE-n 114 may need to prioritize between the HARQ feedback transmission to UE-1 111 (e.g. on PSFCH) and the other communication(s) with the UE-m 116 and/or the base station 122. In another one example, UE-n 114 may benefit from skipping HARQ feedback transmission(s) to save its power/energy, e.g. when UE-n 114 has a low battery level. Example embodiments described herein enable the UE-n 114 to skip transmitting one or multiple HARQ feedback(s) in a controlled and adaptable manner, such that the considered sidelink communication can be benefited, e.g. UE-n 114 can avoid or reduce the number of such collisions as described before, and/or UE-n 114 can reduce its power/energy consumption due to skipping of HARQ feedback transmission(s).

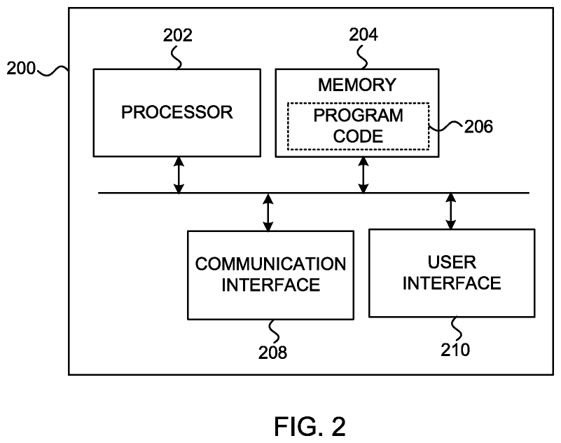

FIG. 2 illustrates an example embodiment of an apparatus 200, for example UE-1 111, UE-2 112, UE-n 114, UE-m 116, or any of base stations 120, 122, 124. The apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise a communication interface 208 configured to enable apparatus 200 to transmit and/or receive information to/from other devices. In one example, apparatus 200 may use communication interface 208 to transmit or receive signaling information and data in accordance with at least one cellular communication protocol. The communication interface may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

The apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like.

When the apparatus 200 is configured to implement some functionality, some component and/or components of the apparatus 200, such as for example the at least one processor 202 and/or the at least one memory 204, may be configured to implement this functionality. Furthermore, when the at least one processor 202 is configured to implement some functionality, this functionality may be implemented using the program code 206 comprised, for example, in the at least one memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (CPUs).

The apparatus 200 comprises means for performing at least one method described herein. In one example, the means comprises the at least one processor 202, the at least one memory 204 including program code 206 configured to, when executed by the at least one processor, cause the apparatus 200 to perform the method.

The apparatus 200 may comprise for example a computing device such as for example a base station, a server, a mobile phone, a tablet computer, a laptop, an internet of things (IoT) device, or the like. Examples of IoT devices include, but are not limited to, consumer electronics, wearables, sensors, and smart home appliances. In one example, the apparatus 200 may comprise a vehicle such as for example a car. Although apparatus 200 is illustrated as a single device it is appreciated that, wherever applicable, functions of the apparatus 200 may be distributed to a plurality of devices, for example to implement example embodiments as a cloud computing service.

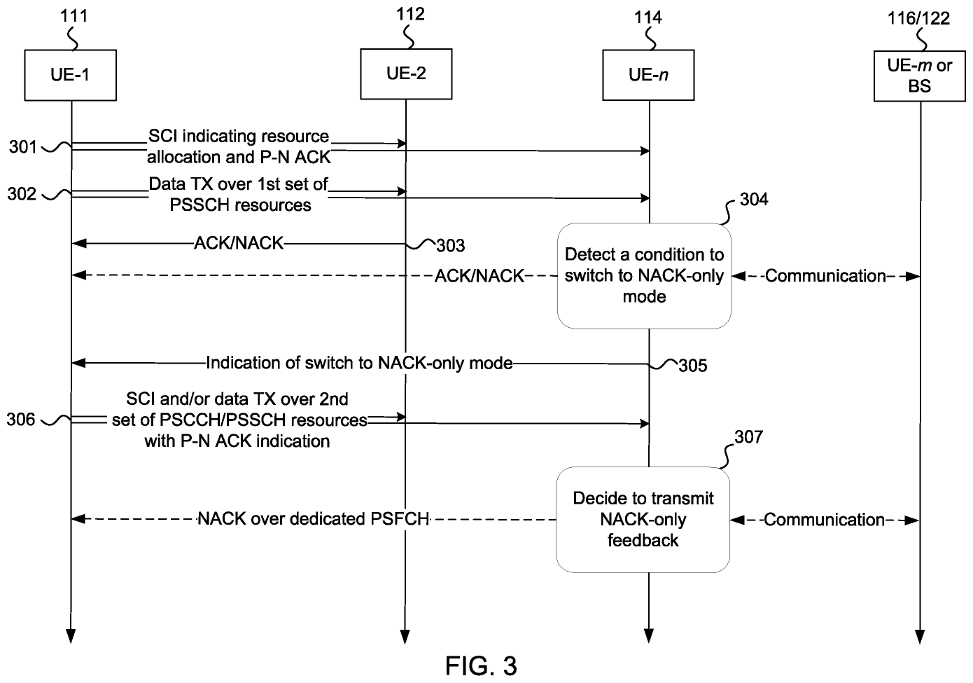

FIG. 3 illustrates an example of communication between devices to skip the transmissions of ACKs, e.g. in order to prioritize between HARQ feedback and other communications, and/or to save power/energy, according to an example embodiment. Even though the procedure is illustrated using sidelink devices UE-1 111, UE-2 112, and UE-n 114 as an example, it is appreciated that similar functionality may be applied in other type of communications as well, for example in multicast communication from a base station to a plurality of UEs. The example embodiments disclosed herein may be also applied to sidelink unicast communication, for example between UE-1 111 and UE-n 114, where UE-n 114 indicates its mode switch to UE-1 111.

At operation 301, the UE-1 111 may transmit first sidelink control information (SCI) indicating a resource allocation of future transmission resource(s). The resource allocation may be also called resource reservation. The resource allocation may be provided to reserve resources for sidelink groupcast transmission of SCI and/or payload data. The sidelink control information may further comprise an indication of the P-N ACK mode associated with the allocated resource(s). The SCI may be transmitted to a group of sidelink receivers, for example UE-2 112 and UE-n 114. Upon reception of the SCI, the UE-2 112 and UE-n 114 may configure the second HARQ mode for the allocated resource(s). Alternatively, the first SCI may not comprise an indication of an HARQ mode and the P-N ACK mode may be preconfigured at UE-2 112 and UE-n 114.

The first SCI may for example indicate the PSCCH/PSSCH resources (first set of PSCCH/PSSCH resources) used for transmitting the first SCI and/or the payload data associated with the first SCI at operation 302. At least one first PSFCH resource may be associated with the first set of PSCCH/PSSCH resources. The first PSFCH resource(s) may be configured to be used by a sidelink receiver, for example UE-n 114, to send feedback according to the second HARQ mode. The first PSFCH resource(s) may be dedicated to a particular sidelink receiver UE of the group of sidelink receiver UEs, for example to UE-n 114. Other UEs may not be therefore allowed to use the first PSFCH resource(s) dedicated to UE-n 114. In addition, the first SCI may also indicate additional PSCCH/PSSCH resources, which may be referred to as a second set of PSCCH/PSSCH resources, reserved for future transmissions of SCI and/or further payload data at operation 306.

The first SCI, or other control information provided by UE-1 111, may further comprise a configuration of at least one second PSFCH resource, which may be configured for indicating a switch of acknowledgement mode. The second PSFCH resource(s) may be different from the first PSFCH resource(s). A sidelink receiver, for example UE-n 114, may use second PSFCH resource(s) to transmit an indication, which may be an implicit indication, of a switch of acknowledgement mode. The second PSFCH resource(s) may be common to the group of sidelink receivers. For example, any member of the group of sidelink receivers may use the second PSFCH resource(s) for indicating the switch of acknowledgement mode, as will be further described below.

At operation 302, the UE-1 111 may transmit data using the first set of PSCCH/PSSCH resources allocated by the first SCI at operation 301. PSCCH/PSSCH resources are provided as an example of transmission resources. The transmission may comprise a sidelink groupcast transmission.

At operation 303, the UE-2 112 may transmit an acknowledgement according to the P-N ACK mode. For example, in response to successful decoding of the payload data, the UE-2 112 may transmit a positive acknowledgement (ACK). In response to unsuccessful decoding of the payload data (decoding failure), the UE-2 112 may transmit a negative acknowledgement (NACK).

At operation 304, the UE-n 114 may detect a condition for switching to the NACK-only mode. For example, UE-n 111 may detect a need for prioritization between HARQ feedback (NACK/ACK) and other activities, for example another communication with UE-m 116 or base station (BS) 112. The UE-n 114 may for example determine that the first PSFCH resource(s) associated with the PSCCH/PSSCH used to receive the data in operation 302, and/or any other future PSFCH resource(s), at least partially collide, for example overlap in time-domain, with the other communication. In order to determine the described collision, UE-n 114 may derive and use the time-domain information of the other communication, e.g. by checking the resource allocation information of the other communication and/or the corresponding response. Prioritizing one of the two colliding communications may be performed in any suitable manner, for example based on priority levels assigned to different types of communications. In another example, at operation 304, the UE-n 114 may detect a need or benefit to save its power/energy, if HARQ feedback is not transmitted via the first PSFCH resource(s) associated with the PSCCH/PSSCH used to receive the data in operation 302, and/or any other future PSFCH resource(s). For example, the condition to switching to the NACK-only mode may comprise detecting the collision with the other communication or detecting entry to a power saving mode.

If the UE-n 114 determines to prioritize the other communication, the UE-n 114 may determine not to transmit the HARQ feedback acknowledgement (ACK/NACK). If the UE-n 114 determines to prioritize the HARQ feedback over the other communication, the UE-n 114 may transmit an acknowledgement (ACK/NACK) according to the P-N ACK mode, as described above for UE-2 112. However, in response to detecting the collision between the first PSFCH resource(s) and the other communication and/or the need to save power/energy, the UE-n 114 may determine to switch to the NACK-only mode (first HARQ mode). This may be done regardless of whether the UE-n 114 determined to transmit the acknowledgement or not in 304.

According to an example embodiment, UE-n 114 may further consider current state of the radio channel when determining whether to switch to the NACK-only mode. For example, determining to switch to the NACK-only mode may be based on detecting at least one condition associated with the state of the radio channel. The radio channel condition(s) may comprise a received signal strength, for example a reference signal received power (RSRP) of the sidelink groupcast transmission. For example, the UE-n 114 may determine to switch to the NACK-only mode if the signal strength is above certain threshold. Another example of the radio channel condition(s) may comprise the measured channel busy ratio (CBR). The CBR may indicate a portion of transmission resource pool(s) for which the received signal strength is above a threshold. The CBR may be measured for example as a portion of sub-channels or resources over a predetermined number of sensed subframes. The UE-n 114 may for example determine to switch to the NACK-only mode if the CBR is below a certain threshold. In this case, successful receptions may dominate the PSCCH/PSSCH transmissions from UE-111 to UE-n 114 and the possibility of missing PSCCH/PSSCH transmission from UE-1 111 may be low. Thus, it may be beneficial for UE-n 114 to switch to the NACK-only mode in such radio channel conditions.

At operation 305, the UE-n 114 may transmit an indication of a switch to the NACK-only mode. The indication of the mode switch may indicate that UE-n 114 will switch from the P-N ACK mode to the NACK-only mode for future PSFCH transmissions (e.g. over further first PSFCH resource(s) dedicated to UE-n 114), which may be associated with the PSCCH/PSSCH receptions via the transmission resources allocated at operation 301. In addition, the indication may further carry information to apply the NACK-only mode for an indicated subset of the future PSFCH transmissions (e.g. over further first PSFCH resource(s) dedicated to UE-n 114), which may be associated with the PSCCH/PSSCH receptions via the transmission resources allocated at operation 301.

The indication of the switch to the NACK-only mode may be transmitted to UE-1 111 and/or the other UEs of the group of sidelink receiver UEs, for example to UE-2 112. UE-1 111 and/or UE-2 112 may receive the indication. Transmitting the indication of the mode switch to the other group members enables the mode switch to be taken into account at the other group members. If the transmission resources allocated at operation 301 and indicated by the received SCI (e.g. the first SCI received in operation 301) are or will be actually used by other group member(s) for sidelink groupcast transmission, for example using an inter-UE resource allocation method, the other group member(s) operating as sidelink groupcast transmitter(s) are thus informed about the mode switch and may adapt their HARQ process(es) accordingly.

The indication of the switch to the NACK-only mode may be transmitted either explicitly or implicitly. An explicit indication may comprise at least one message indicating the switch of acknowledgement mode. Additionally, an explicit indication may further indicate the PSFCH resource(s) where the corresponding indicated acknowledgement mode is applied. The message may comprise any suitable control message. The indication may be for example included in a MAC control element (CE), a radio resource control (RRC) message provided for example over a PC5 interface between sidelink UEs (PC5-RRC/PC5-signaling (PC5-S) message), an upper layer message, or the like. The message may be addressed to at least a group member, e.g. UE-1 111 and/or UE-2 112, and it may indicate that UE-n 114 will switch to the NACK-only mode.

The message(s) may indicate that UE-n 114 switches to use the NACK-only mode to send feedbacks for subsequent sidelink groupcast transmissions over the PSCCH/PSSCH resources indicated in the received SCI at operation 301. Alternatively, the message(s) may indicate a subset of the PSFCH resources (e.g. with respect to time-domain), for which UE-n 114 switches to use the NACK-only mode. Therefore, the indication of the switch to the NACK-only mode may comprise an indication of applying the NACK-only mode to a subset of the transmissions over the allocated PSCCH/PSSCH resources in 301. This enables the UE-n 114 to optimize its acknowledgement mode for different PSFCH resources separately. In this case, UE-n 114, may apply the NACK-only mode for PSFCH transmissions over the indicated subset of resources and still apply the P-N ACK mode for the rest of the PSFCH resources. The UE-1 111 may configure its HARQ process for UE-n 114 accordingly. The UE-1 111 may for example configure the HARQ process to determine whether to retransmit payload data based on applying the NACK-only mode for UE-n to the indicated subset of the allocated transmission resources, though the SCI(s) over the indicated subset of the allocated transmission resources indicates the P-N ACK mode. Thus, in this case, UE-1 111 may consider a corresponding transmission to UE-n 114 over one resource from the indicated subset of resources as failed only if it receives a NACK from UE-n 114, but not a DTX-ed HARQ feedback. However, the UE-1 111 may continue applying the P-N ACK mode for UE-n 114 to PSFCH resources not belonging to the indicated subset.

In case of an implicit indication, the UE-n 114 may use (pre-)configured specific PSFCH resource(s) to send its ACK/NACK feedback. These PSFCH resources configured for indicating the switch of acknowledgement mode may be called second PSFCH resources, in contrast to the first PSFCH resources dedicated to each UE for sending their ACK/NACK feedback. In order to indicate the switch to the NACK-only mode (cf. operation 305), the UE-n 114 may transmit the feedback over the second PSFCH resource(s), instead of over its first PSFCH resource(s). As discussed above, the second PSFCH resource(s) may be different from the first PSFCH resource(s) and be configured to be used for the mode-switch indication.

The second PSFCH resource(s) may be dedicated to particular UE. Therefore, different UEs may have the different PSFCH resource(s) for the implicit mode-switch indication. Alternatively, the second PSFCH resource(s) may common for the group of UEs involved in the groupcast transmission. Even though the second PSFCH resource(s) may be configured for the purpose of indicating the mode switch, the second PSFCH may be also used to indicate the reception status at the sidelink receiver UE(s), by means of transmitting either ACK or a NACK on the second PSFCH resource(s). For example, if the UE-n 114 determines to switch the acknowledgement mode, it may determine not to transmit an acknowledgement at the first PSFCH resource(s) dedicated to UE-n 114. Instead, it may transmit the relevant feedback (ACK/NACK or NACK-only) on the second PSFCH resource(s). If the second PSFCH resource(s) are common to the group of UEs, the UE-1 111 may detect the indication of the UE-n 114 switching to NACK-only mode based on detecting missing feedback from UE-n 114 on the first PSFCH resource(s). In addition, in some embodiments, UE-1 111 may detect the indication of mode switch by further detecting an ACK/NACK on the second PSFCH resource(s). The UE-1 111 may further determine that the previous transmission to UE-n 114 was successful, if the feedback received on the second PSFCH resource(s) was ACK. Alternatively, or additionally, the UE-1 111 may further determine that the previous transmission to UE-n 114 was not successful, if the feedback received on the second PSFCH resource(s) was NACK. The UE-1 111 may then configure its HARQ process according to the NACK-only mode for UE-n 114. For example, the UE-1 111 may start monitoring the first and/or the second PSFCH resources, e.g. the PSFCH resource(s) dedicated to UE-n 114 or the second PSFCH resource(s) common for the group of UEs, for HARQ NACK feedback. If there are multiple sidelink receiver UEs (e.g. multiple UE-n) switching to the NACK-only mode, they may transmit their NACKs over the same second PSFCH resource(s). In this case, the second PSFCH resource(s) may be configured in same or different time slot(s) compared to the first PSFCH resource(s) dedicated to UE-n 114.

An implicit indication of the switch of acknowledgement mode avoids using an explicit message and therefore reduces the signaling overhead and complexity of the system design. In case of signal strength and/or CBR dependent mode switch mentioned before, this approach may also improve robustness without misdetection of the mode switch with HARQ DTX-ed feedback.

The second PSFCH resource(s) may be configured by various means. For example, the UE-n 114 may receive a configuration of the second PSFCH resource(s) from an upper protocol layer such as for example a V2X layer and/or an application layer. Alternatively, the configuration of the second PSFCH resource(s) may be received from UE-1 111, which may operate as a sidelink groupcast transmitter. UE-1 111 may transmit the configuration of the second PSFCH resource(s) to the group of sidelink receiver UEs. The configuration of the second PSFCH resource(s) may be also received from another member of the group of sidelink receiver UEs, for example a group leader UE, which may groupcast the configuration of the second PSFCH resource(s) to the other group members. The configuration of the second PSFCH resource(s) may be also received from the network, for example from base station 122. The configuration of the second PSFCH resource(s) may be for example included in one or more system information blocks (SIB). The second PSFCH resource(s) may be configured by mapping rules (at least in time-domain) between at least the PSCCH/PSSCH resource(s) and associated second PSFCH resource(s).

According to an example embodiment, the indication of the switch to the NACK-only mode may comprise a preconfigured HARQ feedback transmission pattern. This provides another form of an implicit indication of the acknowledgement mode switch. The HARQ feedback transmission pattern may comprise a configured pattern of skipped (not transmitted) acknowledgements, ACK(s), or NACK(s). The pattern may be known at both the sidelink transmitter UE-1 111 and the group of sidelink receivers (e.g. UE-2, . . . , UE-n 114). The pattern may be preconfigured at each device, or, information of the pattern may be exchanged between the devices or received from another device and/or a base station. The sidelink receiver UEs may be configured with different HARQ feedback transmission patterns.

A HARQ feedback transmission pattern indicative of switching to the NACK-only mode may for example comprise N times DTX-ed (skipped) feedback followed by one ACK/NACK. In this example, when UE-n 114 determines to perform a mode switch, the UE-n 114 may skip sending N consecutive HARQ feedbacks before it sends the HARQ feedback. In this case, sending ACK after the N skipped feedbacks may indicate that the N+1 receptions were successful, while sending a NACK after the skipped feedbacks may indicate that the N+1 receptions (or at least some of them) were not successful. Due to the skipping of the N consecutive HARQ feedbacks at UE-n 114, unnecessary retransmissions may be triggered at UE-1 111 before receiving the ACK. However, the approach of applying the HARQ feedback transmission pattern to indicate the mode switch enables to avoid configuring any separate second PSFCH resource(s) for indicating the mode switch. In order to reduce the unnecessary retransmissions, the value of N may be decreased. Value of N may be equal to one or higher.

According to an example embodiment, unnecessary retransmissions may be avoided or reduced as follows. In response to detecting the first missing feedback from UE-n 114, UE-1 111 may determine to transmit N different (new) transport blocks (TBs) before retransmitting the transport block associated with the missing feedback. Therefore, if UE-1 111 detects the mode switch indication from UE-n 114, for example based on the feedback pattern of N missing feedbacks followed by an ACK, which also indicates successful reception of the N+1 transport blocks, transmission resources are not wasted for unnecessary retransmissions triggered by the missing feedback(s). The UE-1 111 may therefore determine to postpone retransmission of the payload data (e.g. a first TB) based on the skipped (missing) feedbacks of the preconfigured feedback pattern and determine to transmit further payload data (e.g. other TBs) before retransmission of the payload data, e.g. which is associated with the PSCCH/PSSCH resource(s) allocated at operation 301. This scheme may be applied for example if the latency requirement of the payload data is relaxed and/or if the value of N is relatively small.

It is further noted that, if the actual HARQ feedback from UE-n 114 happens to be the same as the configured feedback pattern and UE-n 114 has no intention to switch the HARQ feedback mode, the UE-n 114 may transmit to UE-1 111 an explicit indication of the acknowledgement mode (or that the acknowledgment mode should not be changed), which may override the implicit indication observed by UE-1 111. The explicit indication may be provided to UE-1 111, for example by sending a message, as described above. Alternatively, the indication of not changing the acknowledgement mode may be also provided implicitly, for example by transmitting an ACK in the next PSFCH resource dedicated to UE-n 114.

According to an example embodiment, the decision to use either the implicit indication of the mode switch or an explicit message may be determined by considering the outcome of the prioritization of operation 304 and/or the need for sending NACK feedback. For example, the UE-n 114 may determine to transmit an (implicit) indication of the mode switch, in response to prioritizing transmission of HARQ feedback over the other communication. If UE-n 114 determines to prioritize the HARQ feedback over the other communication and NACK feedback needs to be provided, the UE-n 114 may transmit the NACK feedback over the second PSFCH resource(s) to indicate its mode-switch implicitly. However, the UE-n 114 may determine to transmit a message indicative of the mode switch, e.g. in another subframe or time slot, in response to prioritizing the other communication over the transmission of the HARQ feedback.

At operation 306, the UE-1 111 may transmit SCI (second SCI) and/or payload data over the second set of PSCCH/PSSCH resource(s). The second set of PSCCH/PSSCH resource(s) may comprise PSCCH/PSSCH resource(s) allocated for future transmissions at operation 301. The SCI may indicate the P-N ACK mode to be used when providing feedback over PSFCH resource(s) associated with the second set of PSCCH/PSSCH resource(s). The indication of the P-N ACK mode may be however considered as an indication of a default acknowledgement mode. For example, if the UE-n 114 has indicated a switch to the NACK-only mode at operation 305, the UE-n 114 may use the NACK-only mode for providing HARQ feedback for the payload data associated with the second set of PSCCH/PSSCH resource(s) regardless of the indication of the P-N ACK mode in the second SCI.

At operation 307, the UE-n 114 may decide to transmit NACK-only feedback. The UE-n 114 may for example prioritize between the NACK-only feedback and another communication or decide to transmit the NACK-only feedback to save power. Since the UE-n 114 has switched to operate according to the NACK-only mode, the UE-n 114 may determine not to transmit an ACK even if payload data were successfully received. Thus, in this mode, UE-n 114 may only transmit feedback (NACK), if it fails to decode the payload data. If a collision takes place between the first PSFCH resource(s) dedicated to UE-n 114 for providing HARQ feedback to UE-1 111 and other communication activity, UE-n 114 may be configured not to send ACK, which solves the collision problem. Furthermore, UE-1 111 does not need to perform a retransmission due to the missing feedback from UE-n 114. It is further noted that any sidelink receiver UEs that did not indicate the switch to the NACK-only mode may continue to operate according to the P-N ACK mode based on the indication in the second SCI of operation 306. According to an example embodiment, UE-n 114 may prioritize transmission of the NACK over other communication activities, if it fails decoding the payload data. The UE-n 114 may therefore determine to transmit a NACK, in response to unsuccessful decoding of the payload data even if there would be another communication scheduled for the same time period. It is noted that if UE-n 114 intended and decided to use NACK-only mode for saving its energy/power in 304, UE-n 114 may have the same operation in 307, e.g. UE-n 114 may determine not to transmit an ACK even if payload data were successfully received. In addition, it is also noted that UE-n 114 may perform the same operation in 307 upon receiving the SCI and/or data payload from another group member, e.g. UE-2 112, if the mode switch indication has been transmitted to UE-2 112, e.g. in 305.

According to an example embodiment, UE-n 114 may inform its return to the P-N ACK mode implicitly, for example by sending to UE-1 111 at least one ACK over the first PSFCH resource(s) dedicated to UE-n 114. Upon reception of one or multiple ACKs over the first PSFCH resource(s) from UE-n 114, the UE-1 111 may determine that UE-n 114 switches back to the P-N ACK mode. The UE-1 111 may then configure its HARQ process for UE-n 114 according to the P-N ACK mode. Multiple ACK messages may be transmitted by the UE-n 114 to improve robustness for such implicit indication. The ACK may be interpreted as the indication of returning to P-N ACK mode, since it deviates from the NACK-only mode, where positive acknowledgement messages are not sent on the first PSFCH resource(s).

According to the above example embodiments, the UE-1 111 may initially determine to use the P-N ACK mode when groupcasting payload data to the group of sidelink receiver UEs. The use of P-N ACK may be indicated for example as part of the SCI at operation 301. Then, besides monitoring the feedbacks from the sidelink receiver UEs, the UE-1 111 may also monitor and receive one or multiple mode switch indications from one or more of the sidelink receiver UEs, at operation 305. The received mode switch indication(s) may be used by the UE-1 111 to create and/or update a list of sidelink receiver UEs (including for example UE-n 114) that have switched to the NACK-only mode. Therefore, the UE-1 111 may maintain information of any UEs currently using the NACK-only mode. At operation 306, once the UE-n 114 has successfully indicated the mode switch to the UE-1 111, UE-1 111 may send another groupcast transmission with the P-N ACK mode indication over the PSCCH/PSSCH resource(s) reserved at operation 301. However, UE-1 111 may consider the groupcast transmission have failed for UE-n 114 if the UE-1 111 receives a NACK over the first PSFCH resource(s) dedicated to UE-n 114. Missing feedback from UE-n 114 may be considered to indicate successful reception. Determining whether a missing feedback is to be interpreted as a successful transmission may be based on detecting the particular UE, for example UE-n 114, being included in the list of UEs associated with the NACK-only mode. If the UE-1 111 receives an ACK from the UE-n 114, the UE-1 111 may update the list of sidelink receiver UEs such that UE-n 114 is removed from the list of UEs applying the NACK-only mode.

The example embodiments disclosed herein enable to reduce collisions between HARQ feedback and other communications by providing an opportunity for a UE to switch to the NACK-only mode, and/or enable to save the power/energy of a SL UE, in order to reduce the number of necessary HARQ feedback messages. In a groupcast scenario, the dynamically adaptive HARQ modes enables to optimize the HARQ mode for each UE, even at the PSFCH resource subset level. Reliability of transmission may be improved and optimized while reducing the number of collisions between HARQ feedback and other communications.

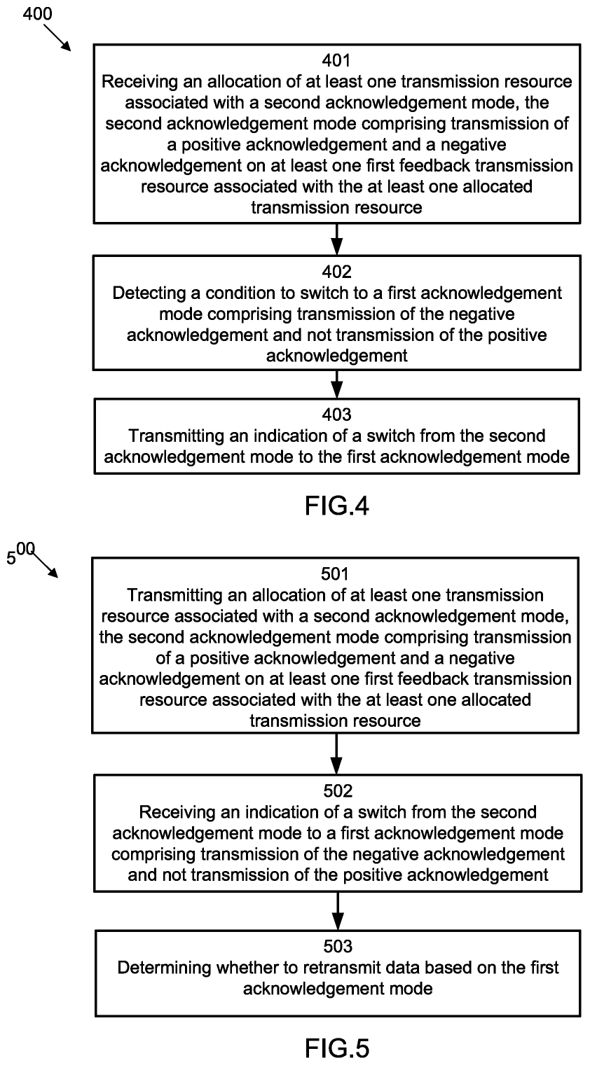

FIG. 4 illustrates an example of a method for transmitting data, according to an example embodiment.

At 401, the method may comprise receiving an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource.

At 402, the method may comprise detecting a condition to switch to a first acknowledgement mode comprising transmission of the negative acknowledgement and not transmission of the positive acknowledgement.

At 403, the method may comprise transmitting an indication of a switch from the second acknowledgement mode to the first acknowledgement mode.

FIG. 5 illustrates an example of a method for receiving data, according to an example embodiment.

At 501, the method may comprise transmitting an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource.

At 502, the method may comprise receiving an indication of a switch to a first acknowledgement mode comprising transmission of the negative acknowledgement and not transmission of the positive acknowledgement.

At 503, the method may comprise determining whether to retransmit data based on the first acknowledgement mode.

Further features of the methods directly result from the functionalities and parameters of the UE-1 111, UE-2 112, or UE-n 114 or any of the base stations 120, 122, 124, as described in the appended claims and throughout the specification, and are therefore not repeated here. Different variations of the methods may be also applied, as described in connection with the various example embodiments.

An apparatus, for example the UE-1 111, UE-2 112, or UE-n 114 or any of the base stations 120, 122, 124 may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate.

Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one non-transitory memory
storing instructions that, when executed with the at least one processor, cause the apparatus at least to:
receive an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource;
detect a condition to switch to a first acknowledgement mode comprising transmission of the negative acknowledgement and not transmission of the positive acknowledgement; and
transmit an indication of a switch from the second acknowledgement mode to the first acknowledgement mode.

2. (canceled)

3. The apparatus according to claim 1, wherein the instructions, when executed with the at least one processor, cause the apparatus to:
receive sidelink control information comprising an indication of the allocation of the at least one transmission resource, wherein the at least one transmission resource is allocated to sidelink transmission to one or multiple sidelink receivers, and wherein the at least one first feedback transmission resource is dedicated to one of the one or multiple sidelink receivers.

4. The apparatus according to claim 1, wherein the instructions, when executed with the at least one processor, cause the apparatus to:
determine to switch to the first acknowledgement mode further based on detecting or measuring at least one radio channel condition.

5. (canceled)

6. The apparatus according to claim 1, wherein the instructions, when executed with the at least one processor, cause the apparatus to:
determine to transmit a control message indicative of the switch to the first acknowledgement mode.

7. (canceled)

8. The apparatus according to claim 1, wherein the instructions, when executed with the at least one processor, cause the apparatus to:
transmit the negative acknowledgement in the first acknowledgement mode on the at least one first feedback transmission resource; or
transmit the negative acknowledgement in the first acknowledgement mode on at least one second feedback transmission resource.

9. The apparatus according to claim 8, wherein the indication of the switch from the second acknowledgement mode to the first acknowledgement mode comprises a positive or negative acknowledgement transmitted on the at least one second feedback transmission resource, wherein the second feedback transmission resource is configured for indicating a switch of acknowledgement mode, and wherein the at least one second feedback transmission resource is different from the at least one first transmission resource.

10. The apparatus according to claim 9, wherein the instructions, when executed with the at least one processor, cause the apparatus to:
transmit an indication of returning to the second acknowledgement mode, wherein the indication of returning to the second acknowledgement mode comprises at least one positive acknowledgement transmitted on the at least one first feedback transmission resource.

11. The apparatus according to claim 9, wherein the instructions, when executed with the at least one processor, cause the apparatus to:
transmit the indication of the switch from the second acknowledgement mode to the first acknowledgement mode to at least one of a sidelink transmitter or to one or multiple sidelink receivers.

12. The apparatus according to claim 8, wherein the instructions, when executed with the at least one processor, cause the apparatus to:
receive a configuration of the at least one second feedback transmission resource from at least one of: an upper protocol layer, the sidelink transmitter, one or multiple sidelink receivers, or a base station.

13. The apparatus according to claim 1, wherein the at least one second feedback transmission resource is common to multiple sidelink receivers.

14. (canceled)

15. (canceled)

16. An apparatus, comprising:
at least one processor; and
at least one non-transitory memory
storing instructions that, when executed with the at least one processor, cause the apparatus at least to:
transmit an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource;
receive an indication of a switch from the second acknowledgement mode to a first acknowledgement mode comprising transmission of the negative acknowledgement and not transmission of the positive acknowledgement; and
determine whether to retransmit data based on the first acknowledgement mode.

17. The apparatus according claim 16, wherein the instructions, when executed with the at least one processor, cause the apparatus to:
retransmit the data, wherein the data is associated with the at least one allocated transmission resource.

18. (canceled)

19. (canceled)

20. The apparatus according claim 16, wherein the indication of the switch from the second acknowledgement mode to the first acknowledgement mode comprises a positive or negative acknowledgement received on the at least one second feedback transmission resource, wherein the second feedback transmission resource is configured for indicating a switch of acknowledgement mode, and wherein the at least one second feedback transmission resource is different from the at least one first feedback transmission resource.

21. The apparatus according to claim 20, wherein the instructions, when executed with the at least one processor, cause the apparatus to:
receive an indication of returning to the second acknowledgement mode, wherein the indication of returning to the second acknowledgement mode comprises at least one positive acknowledgement transmitted on the at least one first feedback transmission resource.

22. (canceled)

23. The apparatus according to claim 20, wherein the at least one second feedback transmission resource is common to one or multiple sidelink receivers.

24. The apparatus according to claim 23, wherein the instructions, when executed with the at least one processor, cause the apparatus to:
detect the indication of the switch from the second acknowledgement mode to the first acknowledgement mode based on detecting a missing feedback from the one of one or multiple sidelink receivers on the at least one first feedback transmission resource.

25. (canceled)

26. (canceled)

27. (canceled)

28. (canceled)

29. (canceled)

30. A method, comprising:
receiving an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource;
detecting a condition to switch to a first acknowledgement mode comprising transmission of the negative acknowledgement and not transmission of the positive acknowledgement; and
transmitting an indication of a switch from the second acknowledgement mode to the first acknowledgement mode.

31. A method, comprising:
transmitting an allocation of at least one transmission resource associated with a second acknowledgement mode, the second acknowledgement mode comprising transmission of a positive acknowledgement and a negative acknowledgement on at least one first feedback transmission resource associated with the at least one allocated transmission resource;
receiving an indication of a switch to a first acknowledgement mode comprising transmission of the negative acknowledgement and not transmission of the positive acknowledgement; and
determining whether to retransmit data based on the first acknowledgement mode.

32. A non-transitory program storage device readable with an apparatus, tangibly embodying a program of instructions executable with the apparatus for performing the method of claim 30.

33. A non-transitory program storage device readable with an apparatus, tangibly embodying a program of instructions executable with the apparatus for performing the method of claim 31.

34. (canceled)

35. (canceled)
